(19) United States
(12) Patent Application Publication
(10) Pub. No.: US 2012/0326516 A1
(43) Pub. Date: Dec. 27, 2012

(54) Fuel Cell Power Generation System with Isolated and Non-Isolated Buses

(75) Inventors: Ranganathan Gurunathan, Bangalore (IN); Arne Ballatine, Palo Alto, CA (US); Carl Cottuli, Franklin, MA (US); Alberto Doronzo, Sunnyvale, CA (US)

(73) Assignee: Bloom Energy Corporation, Sunnyvale, CA (US)

(21) Appl. No.: 13/533,331

(22) Filed: Jun. 26, 2012

Related U.S. Application Data
(60) Provisional application No. 61/501,367, filed on Jun. 27, 2011.

(51) Int. Cl. H02J 3/00; H02J 1/00

(52) U.S. Cl. 307/72; 307/43

(57) ABSTRACT

A fuel cell system provides isolation of one or more DC buses which supply power to a DC IT load from AC noise generated by AC inverters or the AC grid using one or more isolating DC/DC converters.

### CROSS REFERENCE TO RELATED APPLICATIONS

This application claims priority under 35 U.S.C. §119(e) from provisional application No. 61/501,367 filed Jun. 27, 2011. The 61/501,367 provisional application is incorporated by reference herein, in its entirety, for all purposes.

### BACKGROUND

Electrical power systems can be used to provide electrical power to one more loads such as buildings, appliances, lights, tools, air conditioners, heating units, factory equipment and machinery, power storage units, computers, security systems, etc. The electricity used to power loads is often received from an electrical grid. However, the electricity for loads may also be provided through alternative power sources such as fuel cells, solar arrays, wind turbines, thermo-electric devices, batteries, etc. The alternative power sources can be used in conjunction with the electrical grid, and a plurality of alternative power sources may be combined in a single electrical power system. Alternative power sources are generally combined after conversion of their DC output into an alternating current (AC). As a result, synchronization of alternative power sources is required.

In addition, many alternative power sources use machines such as pumps and blowers which run off auxiliary power. Motors for these pumps and blowers are typically 3-phase AC motors which may require speed control. If the alternative power source generates a direct current (DC), the direct current undergoes several states of power conversion prior to delivery to the motor(s). Alternatively, the power to the motors for pumps, blowers, etc. may be provided using the electrical grid, an inverter, and a variable frequency drive. In such a configuration, two stages of power conversion of the inverter are incurred along with two additional stages of power conversion for driving components of the AC driven variable frequency drive. In general, each power conversion stage that is performed adds cost to the system, adds complexity to the system, and lowers the efficiency of the system.

Operating individual distributed generators such as fuel cell generators both with and without a grid reference and in parallel with each other without a grid reference is problematic in that switch-over from current source to voltage source must be accommodated. Additionally, parallel control of many grid independent generators can be problematic.

The combination of various power sources also presents safety issues arising from the potential for inadvertent contact of high voltage nodes.

### SUMMARY

According to one embodiment, a fuel cell system includes at least one power module comprising at least one fuel cell segment configured to supply power to a DC IT load, a first inverter configured to supply an alternating current (AC) to or from an AC grid, a first DC bus electrically connected to an output of the at least one fuel cell segment and to an input for the first inverter, and configured to supply power to an input of the DC IT load, and a first isolating DC/DC converter positioned to isolate the DC IT load from at least one of the first inverter or the AC grid.

According to another embodiment, a method of operating a fuel cell system, includes the steps of supplying a direct current from at least one fuel cell segment to a DC IT load at least in part via a first DC bus and supplying an alternating current (AC) from an AC grid to a first inverter or receiving the AC from the AC grid at the first inverter, wherein the first inverter is connected to the first DC bus and wherein the DC IT load is isolated from at least one of the first inverter or the AC grid by an isolating DC/DC converter during the step of supplying the direct current.

It is to be understood that both the foregoing general description and the following detailed description are exemplary and explanatory only, and are not restrictive of the invention as claimed.

The safety issues arising from the potential for inadvertent contact of high voltage nodes may be addressed by isolating power sources and buses from each other. In embodiments, a DC bus is isolated from connections to an AC grid. In other embodiments, low voltage and high voltage DC buses are isolated from each other.

### DESCRIPTION OF THE DRAWINGS

FIG. 1A is a block diagram illustrating a fuel cell system according to an embodiment.

FIG. 1B is a block diagram illustrating a fuel cell system according to another embodiment.

FIG. 1C is a block diagram illustrating a fuel cell system according to yet another embodiment.

FIG. 2 is a block diagrams illustrating a fuel cell system having multiple isolated and non-isolated DC buses according to embodiments.

FIG. 3 is a block diagram illustrating a fuel cell system that utilizes an isolated low voltage DC bus according to embodiments.

FIG. 4 is a block diagram illustrating a fuel cell system having a non-isolated upstream

DC/DC converter and an isolated downstream DC/DC converter according to embodiments.

FIG. 5 is a block diagram illustrating a fuel cell system having dual buses according to embodiments.

FIGS. 6A-6H are block diagrams illustrating a configurable fuel cell system according to embodiments.

### DETAILED DESCRIPTION

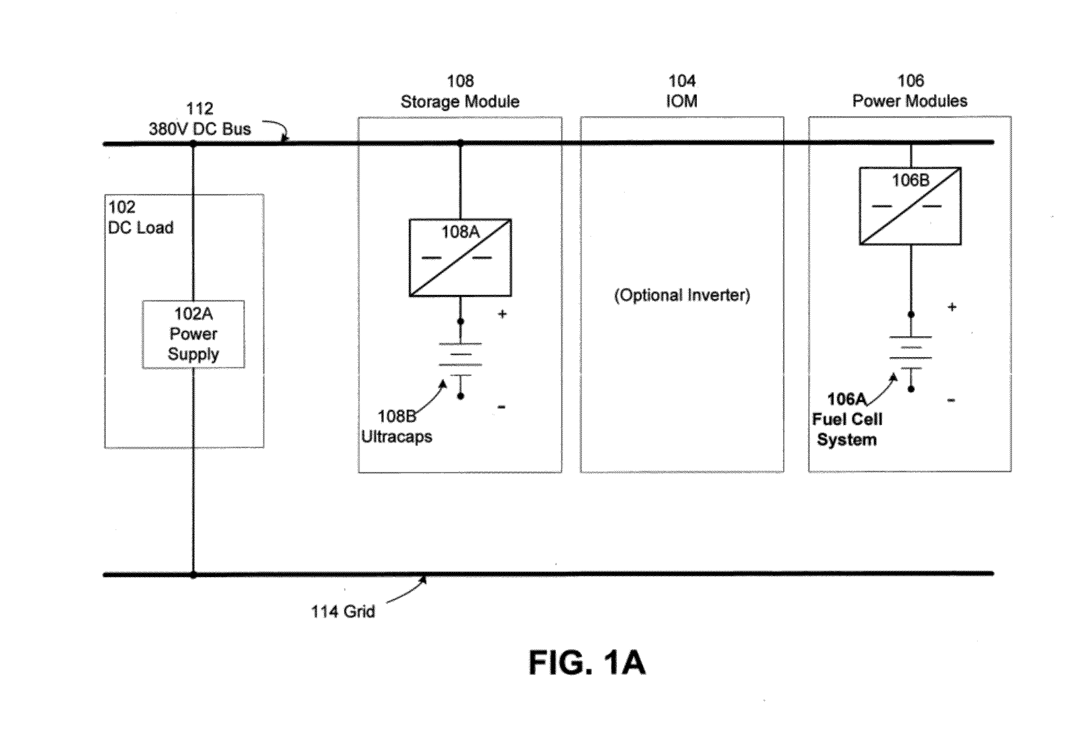

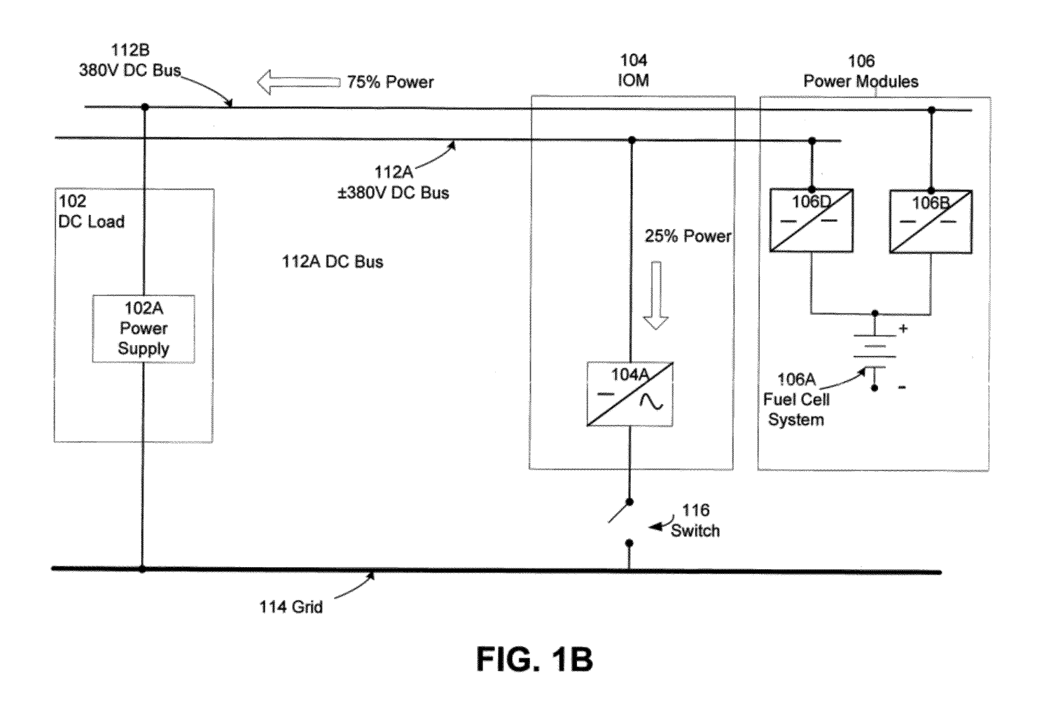

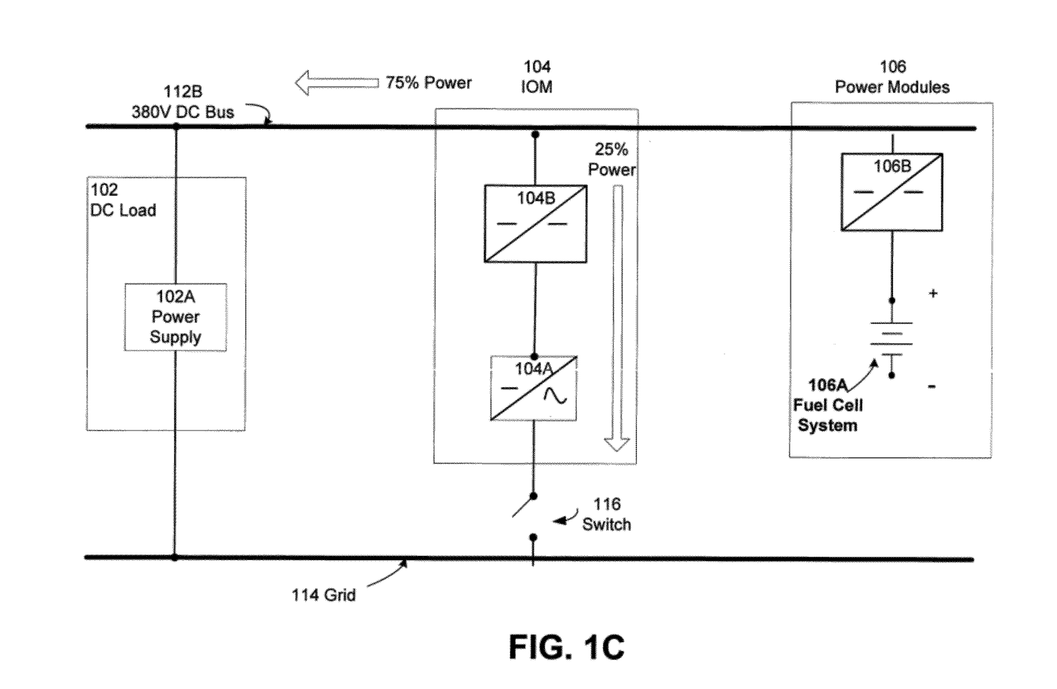

Referring to FIG. 1A, a fuel cell system according to an embodiment includes a DC load 102, such as a data center (i.e., an information technology system including one or more of computer server(s), router(s), rack(s), power supply connections and other components found in a data center (which may be referred to collectively as an “IT load”), a medical device (e.g., a CT scanner) or an electric vehicle charging station, an input/output module (IOM) 104 and one or more power modules 106. If there is more than one power module 106, for example six to ten modules 106, then each power module may comprise its own housing.

The IOM 104 may comprise one or more power conditioning components. The power conditioning components may include components for converting DC power to AC power, such as a DC/AC inverter 104A shown in FIG. 1B, (e.g., a DC/AC inverter described in U.S. Pat. No. 7,705,490, incorporated herein by reference in its entirety), electrical connectors for AC power output to the grid, circuits for managing electrical transients, a system controller (e.g., a computer or dedicated control logic device or circuit), etc. The power conditioning components may be designed to convert DC power from the fuel cell modules to different AC voltages and frequencies. Designs for 208V, 60 Hz; 480V, 60 Hz; 415V, 50 Hz and other common voltages and frequencies may be provided.

Each power module 106 cabinet is configured to house one or more hot boxes. Each hot box contains one or more stacks or columns of fuel cells 106A (generally referred to as “segments”), such as one or more stacks or columns of solid oxide fuel cells having a ceramic oxide electrolyte separated by conductive interconnect plates. Other fuel cell types, such as PEM, molten carbonate, phosphoric acid, etc. may also be used.

Fuel cells are often combined into units called “stacks” in which the fuel cells are electrically connected in series and separated by electrically conductive interconnects, such as gas separator plates which function as interconnects. A fuel cell stack may contain conductive end plates on its ends. A generalization of a fuel cell stack is the so-called fuel cell segment or column, which can contain one or more fuel cell stacks connected in series (e.g., where the end plate of one stack is connected electrically to an end plate of the next stack). A fuel cell segment or column may contain electrical leads which output the direct current from the segment or column to a power conditioning system. A fuel cell system can include one or more fuel cell columns, each of which may contain one or more fuel cell stacks, such as solid oxide fuel cell stacks.

The fuel cell stacks may be internally manifolded for fuel and externally manifolded for air, where only the fuel inlet and exhaust risers extend through openings in the fuel cell layers and/or in the interconnect plates between the fuel cells, as described in U.S. Pat. No. 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

Power modules may also comprise other generators of direct current, such as solar cell, wind turbine, geothermal or hydroelectric power generators.

The segment(s) 106A of fuel cells may be connected to one or more DC buses 112 such as split DC bus(es), by one or more DC/DC converters 106B located in module 106. The DC/DC converters 106B may be located in the IOM 104 instead of the power modules 106.

The system may also optionally include an energy storage module 108, such as a bank of supercapacitors or batteries or one or more flywheels 108B. The storage device 108B may also be connected to the DC bus 112 using one or more DC/DC converters 108A as shown in FIG. 1A. Alternatively, the storage devices may be located in the power module 106 or together with the load 102.

As shown in FIG. 1B, the bus 112 may comprise a bipolar DC bus 112A and a unipolar DC bus 112B, such that one or more power modules 106 (or columns in one module) are connected to bus 112A and one or more other power modules (or other columns in one module) are connected to bus 112B. Unipolar DC bus 112B is connected to the DC load 102, while bipolar DC bus 112A is connected to an inverter 104A in IOM 104. The output from the inverter is provided to the grid 114 or to an AC load.

The fuel cell system and the grid 114 may be electrically connected to the power supply 102A of the load 102 (e.g., an IT load having dual A and B side inputs). The power supply 102A may include using a control logic unit and an AC/DC converter to convert back up power from the grid 114 to DC power in case power from modules 106 is not available or not sufficient. Logic unit may be a computer or processor which switches power between the primary power from bus 112A and backup power from grid 114 using a switch or relay.

A second switch 116 controls the electrical connection between the IOM 104 and the grid 114. Switch 116 may controlled by the control logic unit or by another system controller.

FIG. 1C illustrates an alternative embodiment of the invention, where all (e.g., 2-10, such as 6) power modules 106 are connected in parallel to a single unipolar DC bus 112B. Bus 112B provides power to the load 102 and to the DC/DC converter 104B of IOM 104. A bipolar bus connects converter 104B with inverter 104A in IOM 104.

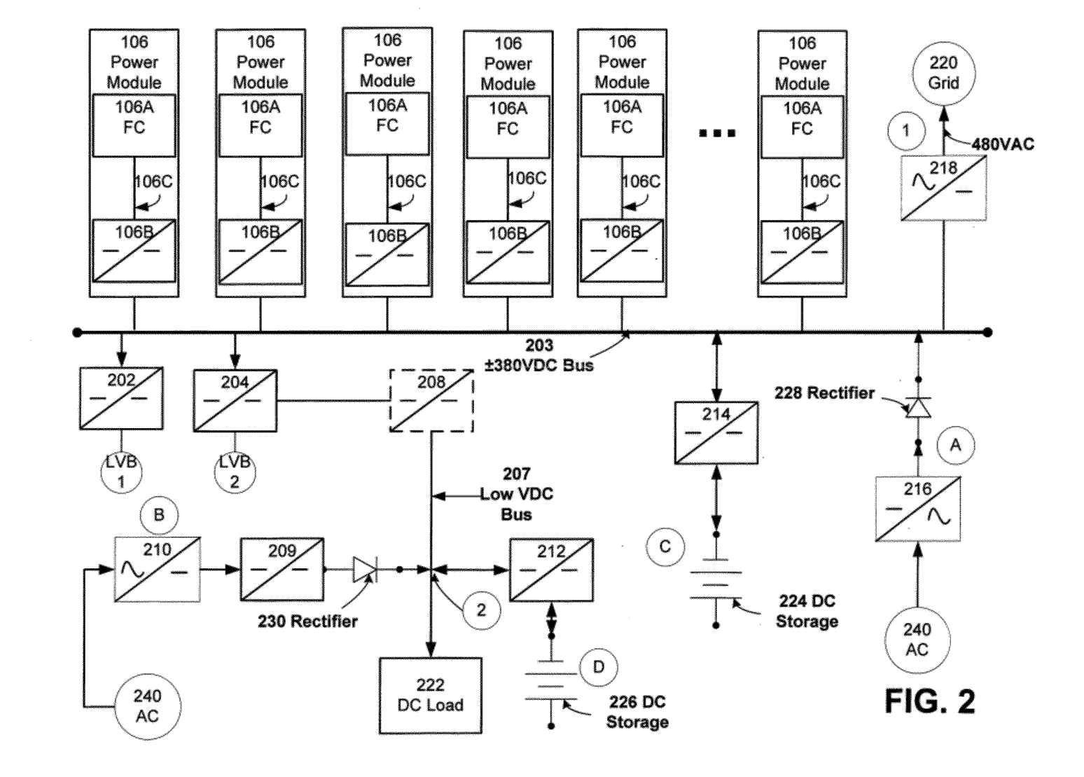

FIG. 2 is a block diagram illustrating a fuel cell system having multiple isolated and non-isolated buses according to embodiment. As illustrated in FIG. 2, any number of power modules 106 are connected to a DC bus 203. Each power module comprises one or more FC systems 106A connected to one or more a DC/DC converters 106B via a fuel cell bus 106C. While six power modules 106 are illustrated in FIG. 2, any suitable number of power modules 106 may be used to supply power to the DC bus 203. In one embodiment, the DC/DC converters 106B are non-isolating. In another embodiment, the DC/DC converters 106B may provide isolation between the fuel cell bus 106C and the DC bus 203 (i.e., the converters 106B are isolating).

The DC bus 203 may be of positive or negative polarity. In an embodiment, the DC bus 203 is a split (or bipolar) bus that includes a positive bus, negative bus and a neutral bus. For example, a bipolar DC bus 203 may provide +380 VDC at the positive bus relative to the neutral and −380 VDC at the negative bus relative to the neutral. The total magnitude of the voltage in this example as measured between the positive and negative buses is 760 VDC.

In an embodiment, the DC bus 203 is connected to a DC/AC inverter 218 that supplies 480 VAC to a grid 220. The DC power fed to the inverter 218 may be bipolar (+/−380 VDC) or unipolar (380 VDC). In still another embodiment, an inverter 216 is connected to a source of AC, such as grid or a diesel generator 240 and the DC bus 203. The DC output of the inverter 216 (Circle A) is passed through a rectifier 228 (e.g., a diode), such as a power factor corrected rectifier, that is used to prevent current from flowing from the DC bus 203 to the AC source 240. The AC source 240 may supply 120 VAC, 420 VAC, 208 VAC, 3-phase or 480 VAC, 3-phase.

In another embodiment, the DC bus 203 is connected to a DC/DC converter 214 to provide voltage to a DC storage device 224, such as a battery or a super capacitor. The energy stored in DC storage device 224 may be supplied back to the DC bus 203 via the DC/DC converter 214 (Circle C).

In an embodiment, the DC bus 203 is connected to one or more low voltage DC buses.

As illustrated a DC/DC down converter 202 connected to bus 203 supplies a first low voltage to a low voltage DC bus 1, a second down converter 204 (e.g., a Buck converter) connected to bus 203 supplies a second low voltage to a low voltage DC bus 2, a third down converter 208 connected in series with down converter 204 provides a third low voltage to low voltage DC bus 207 by down converting the high voltage (e.g., +/−380V) from bus 203 to a lower voltage. DC/DC converter 208 down converts the voltage output from DC/DC converter 204. Low voltage DC bus 207 may also be provided with power from different sources as discussed below. The DC voltage supplied to low voltage DC bus 1, low voltage DC bus 2 and the low voltage DC bus 207 may be positive or negative referenced to a common node or center tap, such as +/−48 VDC, or may be positive or negative unipolar referenced to ground.

In an embodiment, the DC/DC converters 202 and 204 may provide isolation between the input and output terminals (i.e., DC/DC converters 202, 204 are isolating converters). The outputs of these converters are thus unaffected by the noise that may introduced to the DC bus 203 by the grid 220, 240 and/or the inverters 210, 218.

In yet another embodiment, a “super” converter 204 is connected to bus 203 that provides multiple outputs to supply various low voltage DC buses. The super converter may also supply DC power to one or more inverters (not illustrated) to supply AC voltage to various AC buses (not illustrated).

The voltage on bus 207 may be set based on the requirements of DC load 222 (e.g., an ITC DC load). The desired voltage may be achieved by connecting one or more DC/DC converters in series to step down the voltage from the DC bus 203. For example, a series of DC/DC down converters 204 and 208 produces an output voltage of +/−48 VDC that supplies a DC load, such as an IT load, 222 made up of devices operating in an information technology (IT) system. The IT system may include one or more of computer server(s), router(s), rack(s), power supply connections and other components found in a data center environment. The DC/DC down converters 204 and 208 may be configured to produce other voltages, for example, unipolar 380V, unipolar 600V, +/−12 VDC, +/−24 VDC and +/−36 VDC.

In an embodiment, the DC/DC converter 208 may output a voltage that is determined by commands issued by the DC load 222. The DC/DC down converters 202, 204 and or 208 may also operate to produce a DC voltage suitable for charging an electric vehicle, for example, 600 VDC.

In another embodiment, the power on the low voltage DC bus 207 may be provided to a DC/DC converter 212 to charge a DC storage device 226 (Circle D), such as a battery or a super capacitor. The energy stored in DC storage device 226 may be supplied back to the low voltage DC bus 207 via the DC/DC converter 212.

The low voltage DC bus 207 may also be supplied (at Circle 2) by an AC source 240, such as grid or a diesel generator. The AC source 240 may supply 120 VAC, 420 VAC, 208 VAC, 3-phase and 480 VAC, 3-phase. The AC source 240 is connected to an inverter 210 (Circle B). The DC output of the inverter 210 is passed through at least one isolating DC/DC converter 209 (e.g., a Buck converter) to arrive at the desired voltage for low voltage DC bus 207. In an embodiment a rectifier 230, such as a power factor corrected rectifier (e.g., a diode), is used to prevent current from flowing from the low voltage DC bus 207 to the AC source 240.

It will be appreciated that connections to the grid through inverters 210, 216 and 218 may be bidirectional.

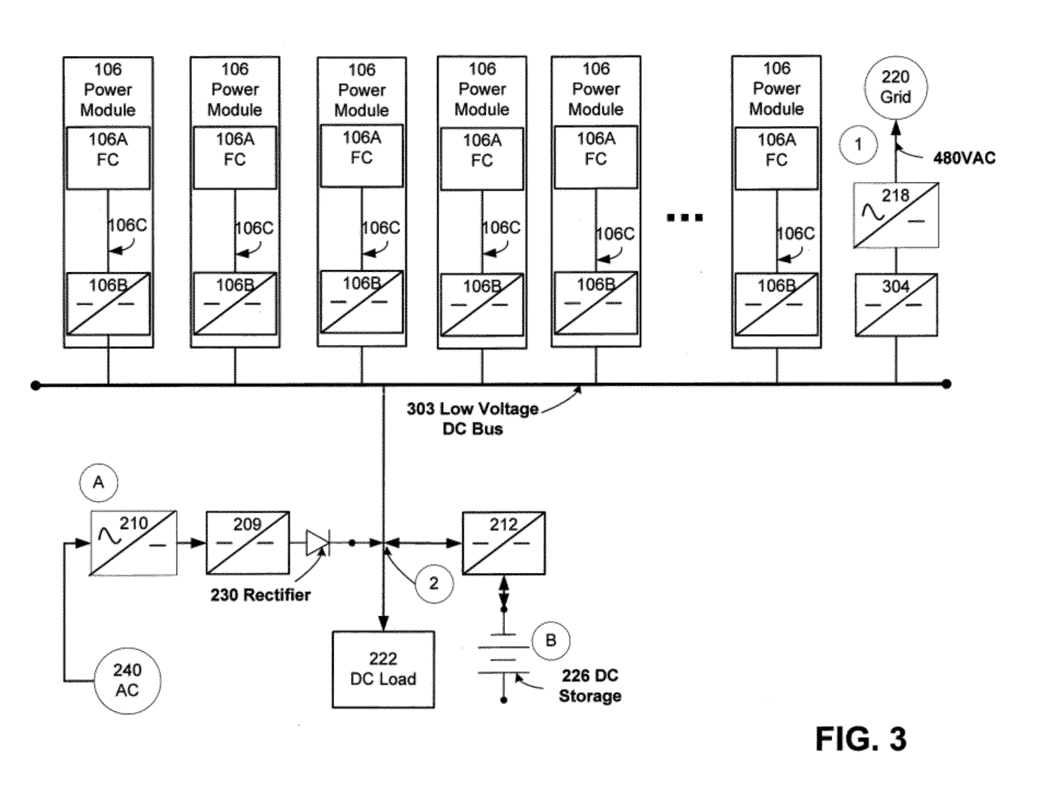

FIG. 3 is a block diagram illustrating a fuel cell system that omits isolating DC/DC converters 202, 204 and utilizes a low voltage DC bus according to an alternative embodiment.

As illustrated in FIG. 3, any number of power modules 106 are connected a low voltage

DC bus 303. In an embodiment, the DC/DC converters 106B are non-isolating Buck converters which convert a high (e.g., 380 VDC) voltage to much lower voltage. Non-isolating converters 106B are more efficient than isolating converters. The low voltage DC bus 303 may be of positive or negative polarity. For example, the low voltage DC bus may be unipolar or bipolar +/−12 VDC, +/−24 VDC, +/−36 VDC and 48 VDC.

Isolation of the low voltage DC bus 303 from the AC signals produced by grid 220, 240 and/or inverters 218, 210 is provided via an isolating upconverting (boost) DC/DC converter 304 that supplies 380 VDC to the inverter 218 (i.e., converter 304 is an isolating converter which boosts the low voltage on bus 203 to a higher voltage). The inverter 218 supplies 480 VAC to a grid 220 (Circle 1). Isolation is also provided by an isolating DC/DC converter 209 as previously described.

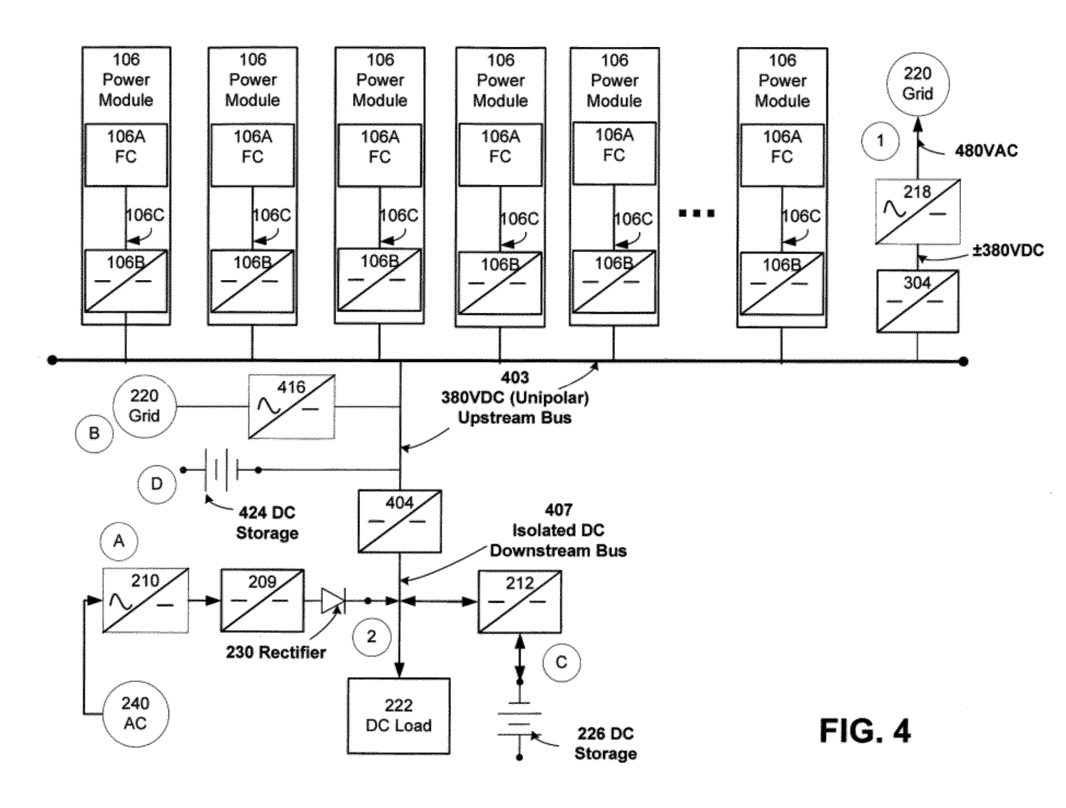

FIG. 4 is a block diagram illustrating a fuel cell system having a non-isolated upstream DC/DC converter(s) and an isolated downstream DC/DC converter(s) according to another embodiment.

As illustrated in FIG. 4, any number of power modules 106 are connected to an upstream unipolar DC bus 403. The upstream DC bus 403 may be of positive or negative polarity. For example, the upstream DC bus may be a +380 VDC bus. Alternatively, the upstream voltage may be selected for near 1:1 conversion from the fuel cell bus. In an embodiment, the DC/DC converters 106B are non-isolating.

Isolation of the upstream DC bus 403 from the AC signals generated by the grid 220 and/or inverter 218 is provided via an isolating upconverting DC/DC converter 304 that supplies bipolar +/−380 VDC to the inverter 218. The inverter 218 supplies 480 VAC to a grid 220 (Circle 1).

In an embodiment, isolation is also provided by an isolating DC/DC down converting (e.g., Buck) converter 404 to a downstream DC bus 407. While only a single isolating DC/DC down converter 404 is illustrated, any number of such converters may be connected to upstream bus 403. Additional non-isolating down converters may be connected in series to isolating DC/DC down converter 404 to produce a desired low voltage supply for DC load 222.

The upstream bus may receive power from a DC storage device 424 (Circle D) and the grid 220 via an inverter 416 (Circle B). Due to the presence of isolating DC/DC converter 404, an isolating converter may be omitted between storage device 424 or grid 220 and DC load 222. The isolated DC downstream bus 407 may also be supplied down stream of isolating DC/DC converter 404 (at Circle 2) by an AC source 240, such as grid or a diesel generator. The AC source 240 may supply 120 VAC, 420 VAC, 208 VAC, 3-phase and 480 VAC, 3-phase. The AC source 240 is connected to an inverter 210 (Circle A). The DC output of the inverter 210 is passed through at least one isolating DC/DC converter 209 to arrive at the desired voltage for downstream bus 407. In an embodiment, a rectifier 230, such as a power factor corrected rectifier, is used to prevent current from flowing from the downstream bus 407 to the AC source 240.

It will be appreciated that connections to the grid through inverters 210, 416 and 218 may be bidirectional.

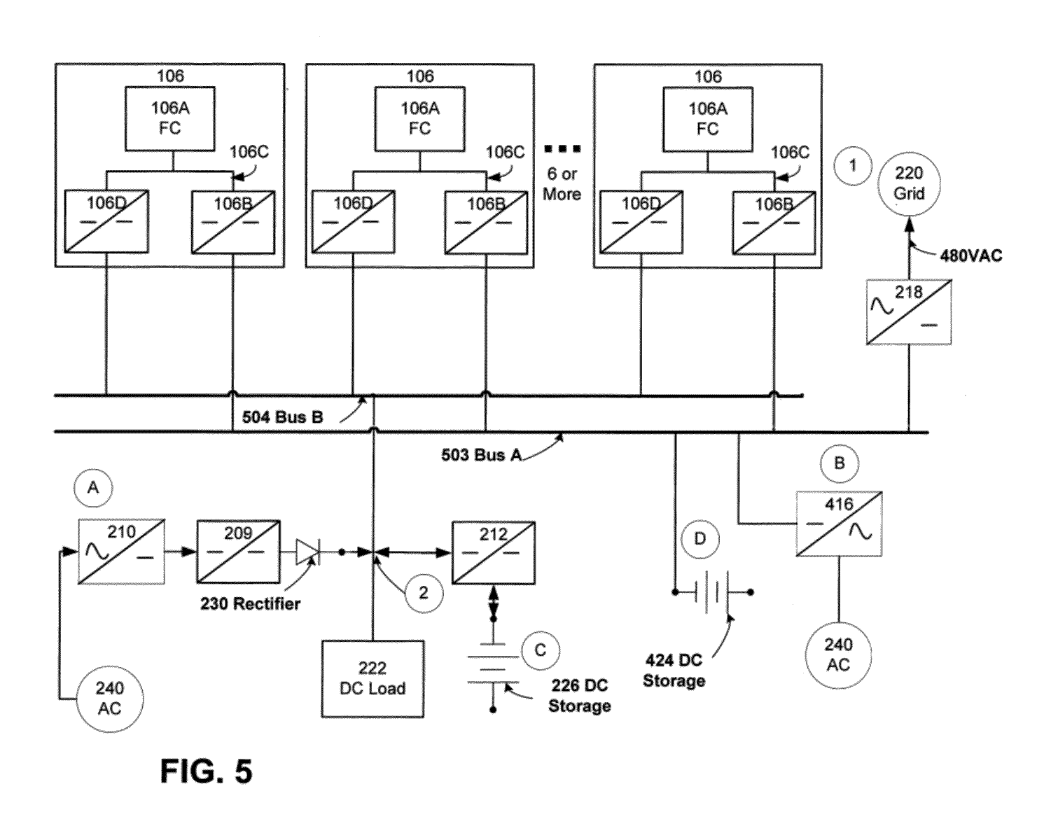

FIG. 5 is a block diagram illustrating a fuel cell system having dual buses according to another embodiment.

As illustrated in FIG. 5, six or more power modules 106 are configured to connect to two independent buses. A power module 106 includes a fuel cell system 106A that connects in parallel to two DC/DC converters 106B and 106D. The output of one of the DC/DC converters 106B is connected to DC bus A 503. In an embodiment, the converters that supply power to DC bus A 503 are non-isolating converters. The output of the other of the two DC/DC converters 106D is connected to DC bus B 504. In an embodiment, the converters that supply power to DC bus B 504 are isolating converters.

In an embodiment DC bus A 503 provides +/−380 VDC to an inverter 218. The output of inverter 218, for example, 480 VAC, is provided to the grid 220 (Circle 1). The DC bus A 503 may also be supplied power from an AC source 240 through inverter 416 and from a DC storage device 424 (Circles B and D).

In an embodiment, DC bus B 504 may supply power to a DC load 222. The DC load may also be provided power from an AC source 240, such as grid or a diesel generator. The AC source 240 may supply 120 VAC, 420 VAC, 208 VAC, 3-phase and 480 VAC, 3-phase. The AC source 240 is connected to an inverter 210 (Circle A). The DC output of the inverter 210 is passed through at least one isolating DC/DC converter 209 to arrive at the desired voltage for DC bus B 504. In an embodiment, a rectifier 230, such as a power factor corrected rectifier, is used to prevent current from flowing from DC bus B 504 to the AC source 240 or DC storage device 226 (Circle C). Thus, the more efficient non-isolating converters are used to supply power to the grid, which is not affected by noise from the grid and/or the inverters, while the isolating converters are used to supply power to the IT load 222 which is affected by the grid noise and/or the inverters.

In an embodiment, the power modules 106 may be replaced by a DC generator, such as a micro turbine, wind turbine or PV array. The DC output is taken before the inverter stage.

In an embodiment, the various inverters and/or converters described above (e.g., described with respect to any one or more of FIGS. 2, 4 and 5) may selectively share the base load unequally (e.g., “percentage share the base” load selectivity). For example, the various rectifiers and DC/DC converters may have different power output ratings. Based on the load, they should proportionally share an amount of base load in steady state conditions. As various units are brought on or off line, the inverters and/or converters are configured to “walk into” the load thereby providing for a stable DC bus. The selective load sharing capability of the system components may be controlled in parallel by a controller to adjust the load share of each power source and each inverter and/or converter dynamically. The load share may also be controlled to optimize energy costs from the power sources (for example, the cost of using power from electric grid versus fuel costs associated with operating the power modules) based on commercial drivers.

As will be appreciated, the voltage outputs of the systems illustrated in FIGS. 2-5 are not limiting. Power conversion devices may be used to produce any voltage needed to provide power to any load. For example, a fuel cell system according to embodiments hereof may be configured to provide outputs of negative 48 VDC, +/−(bipolar) 380 VDC for feeding to inverters which create 480 VAC and an output of 300 VDC or 380 VDC for powering high voltage blowers. Another fuel cell system according to embodiments hereof may be configured to provide outputs of negative 48 VDC, +/−(bipolar) 380 VDC for feeding to inverters which create 480 VAC, and an output of 12 VDC or 24 VDC for powering low power auxiliaries such as valves and control computers.

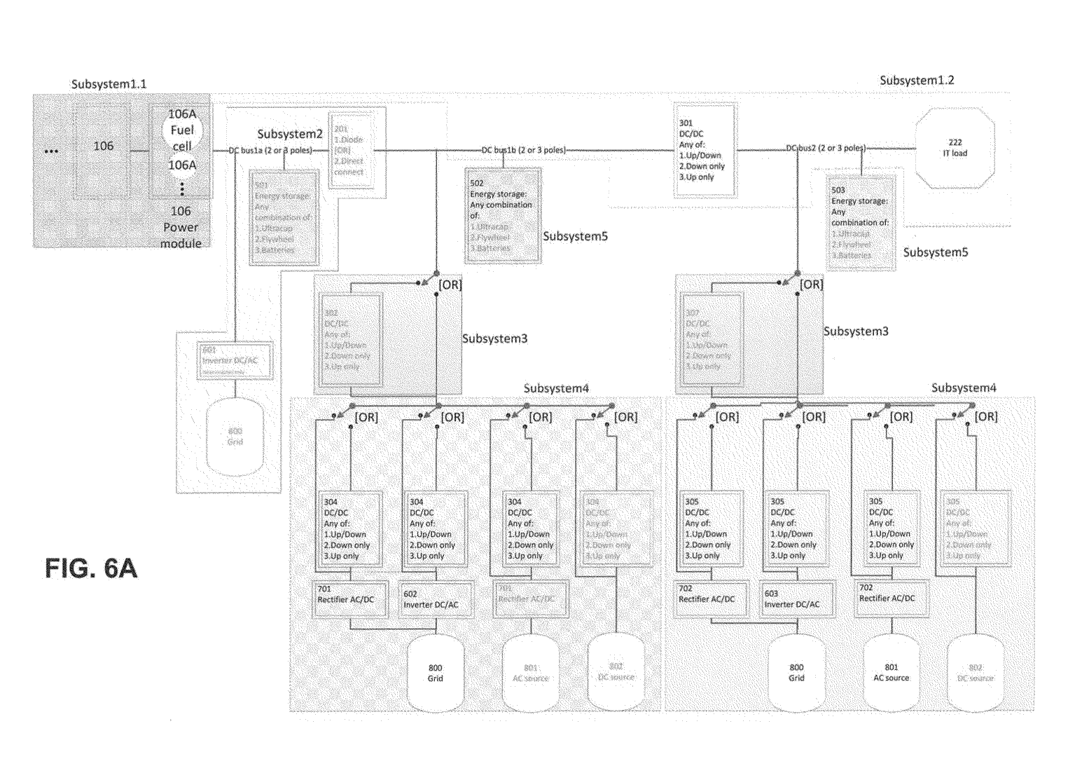

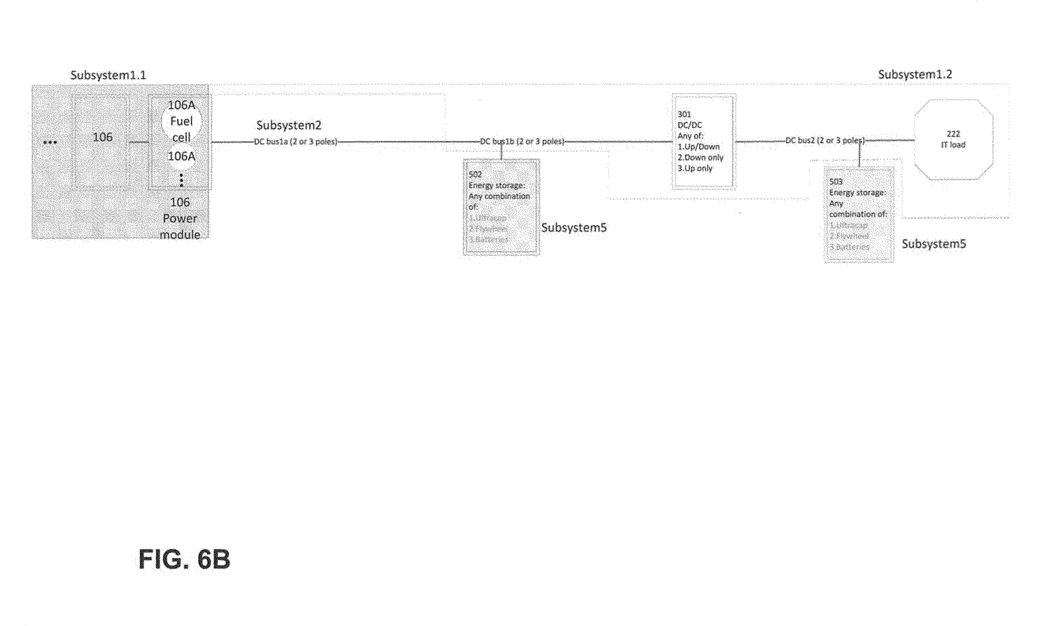

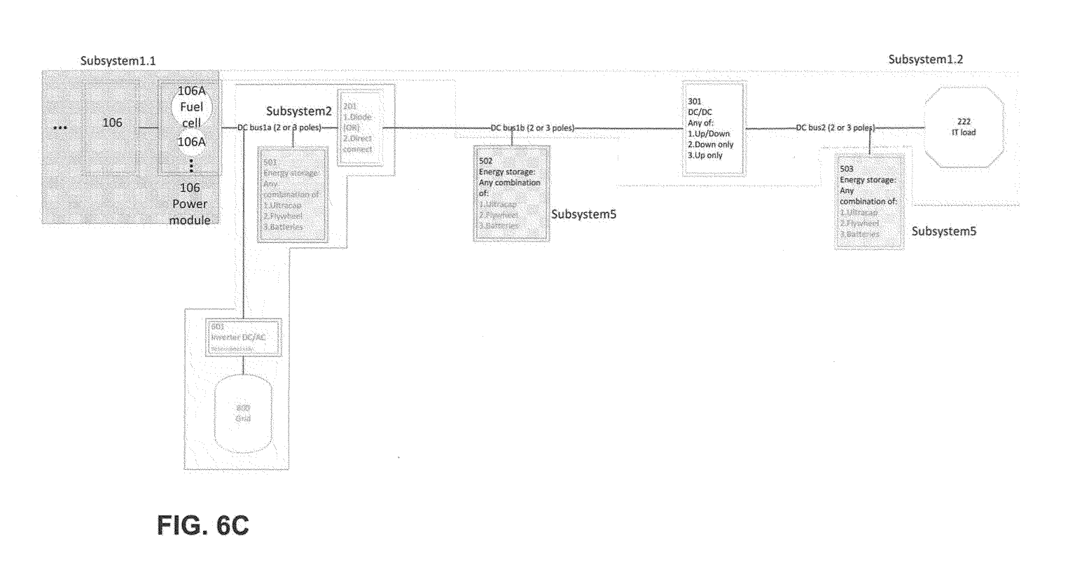

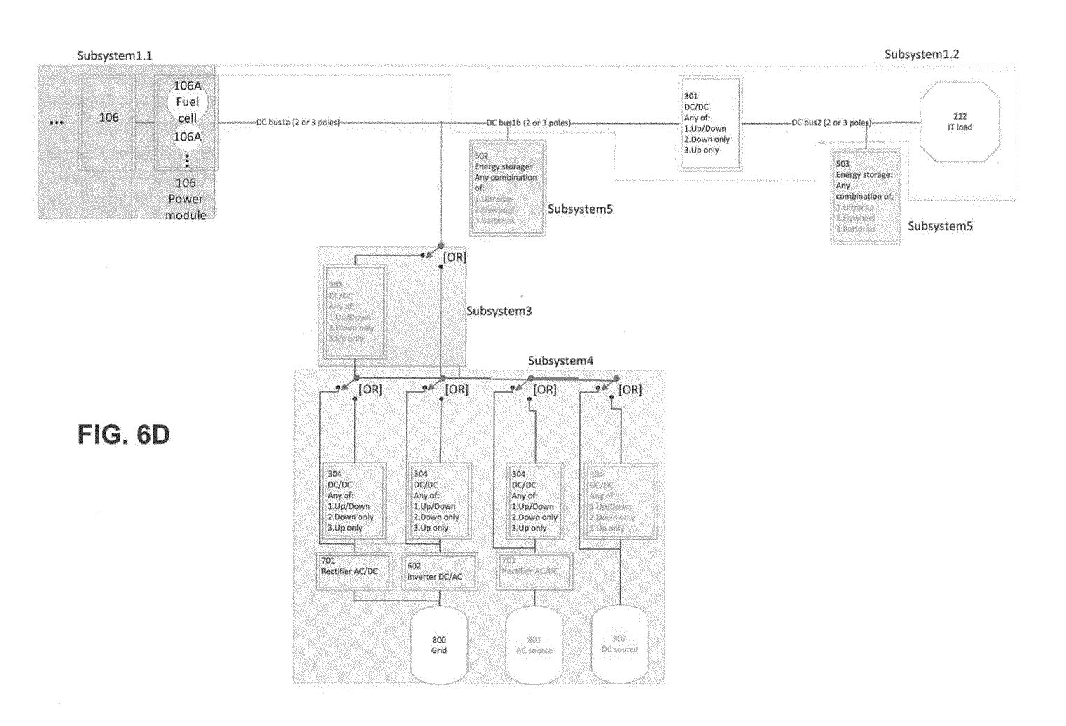

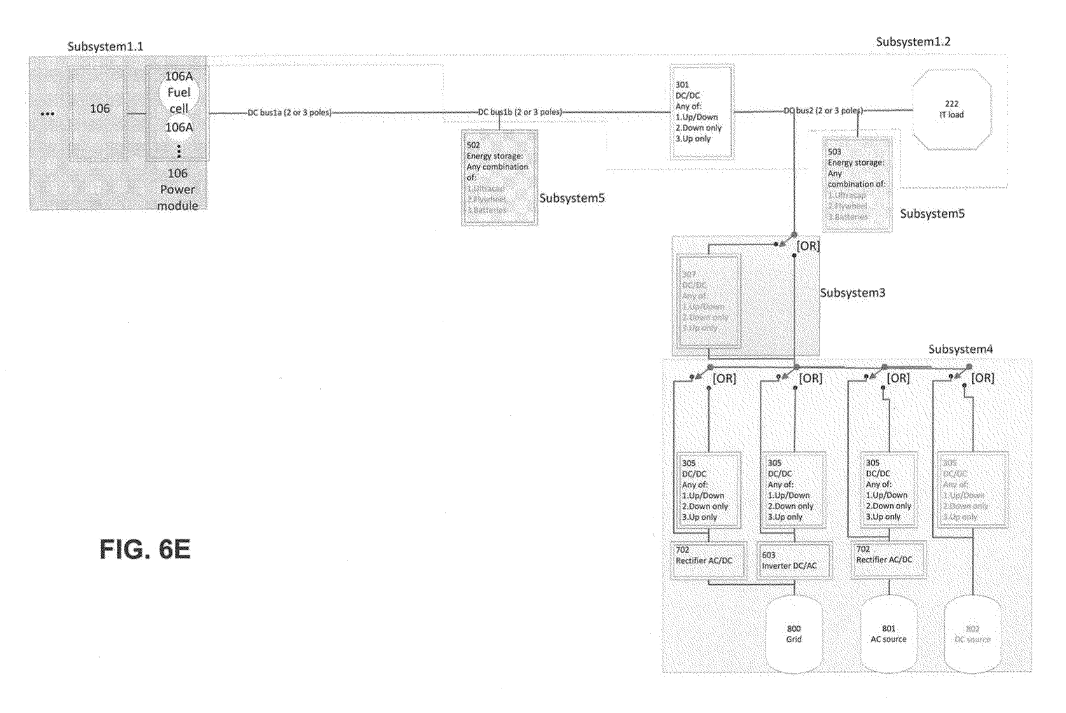

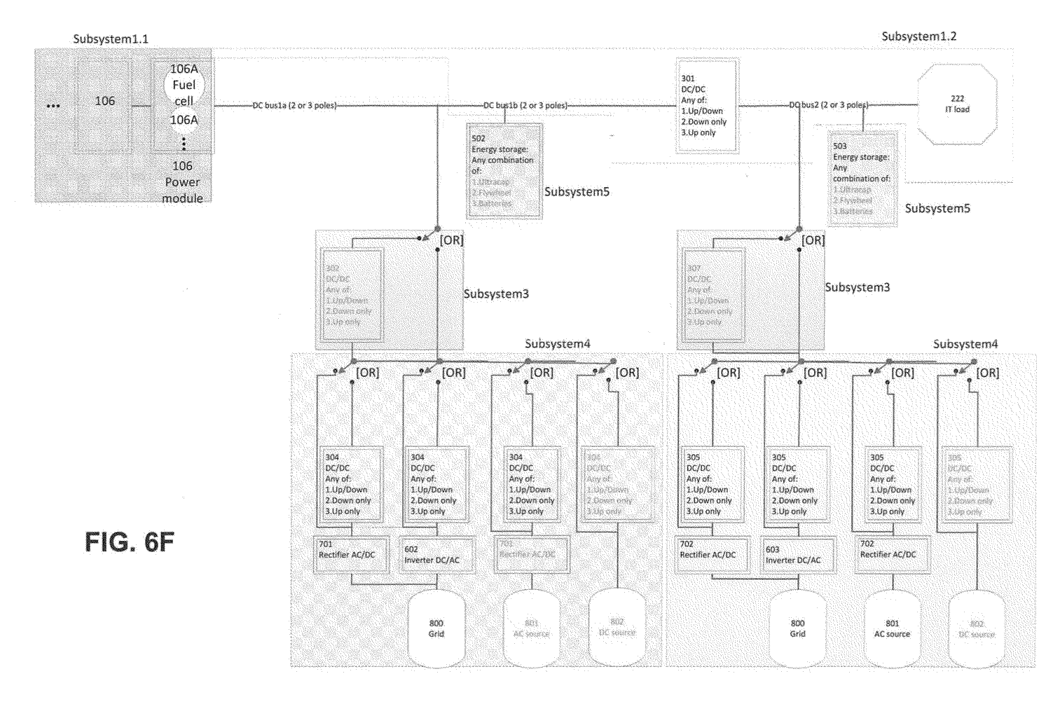

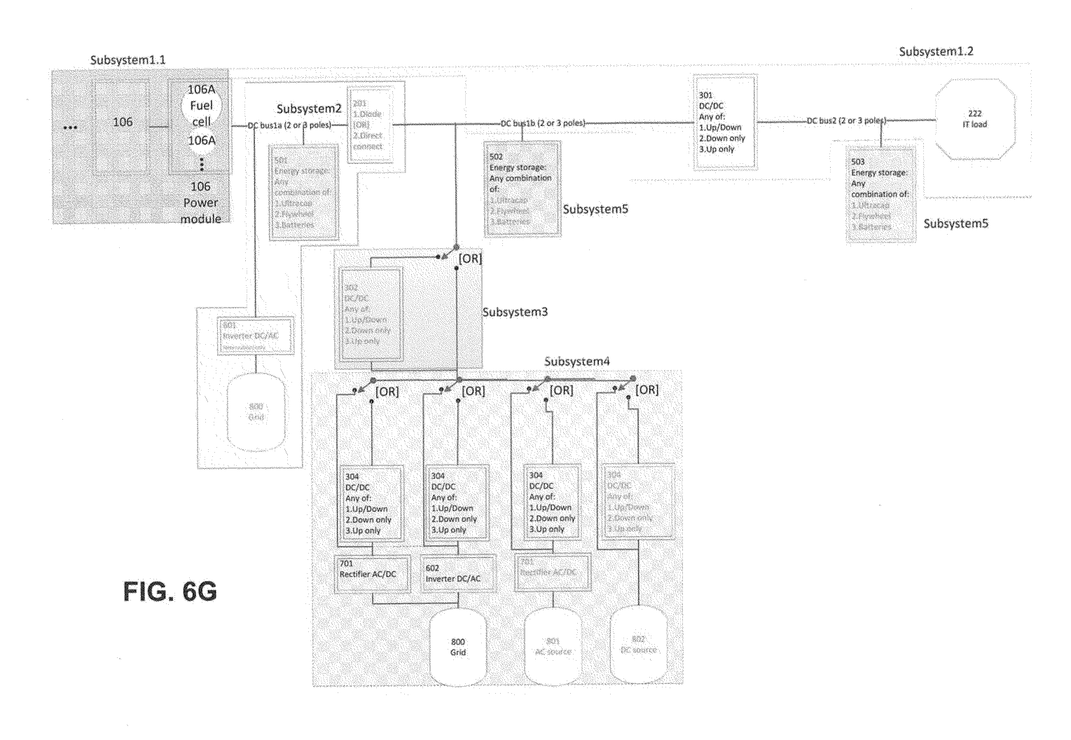

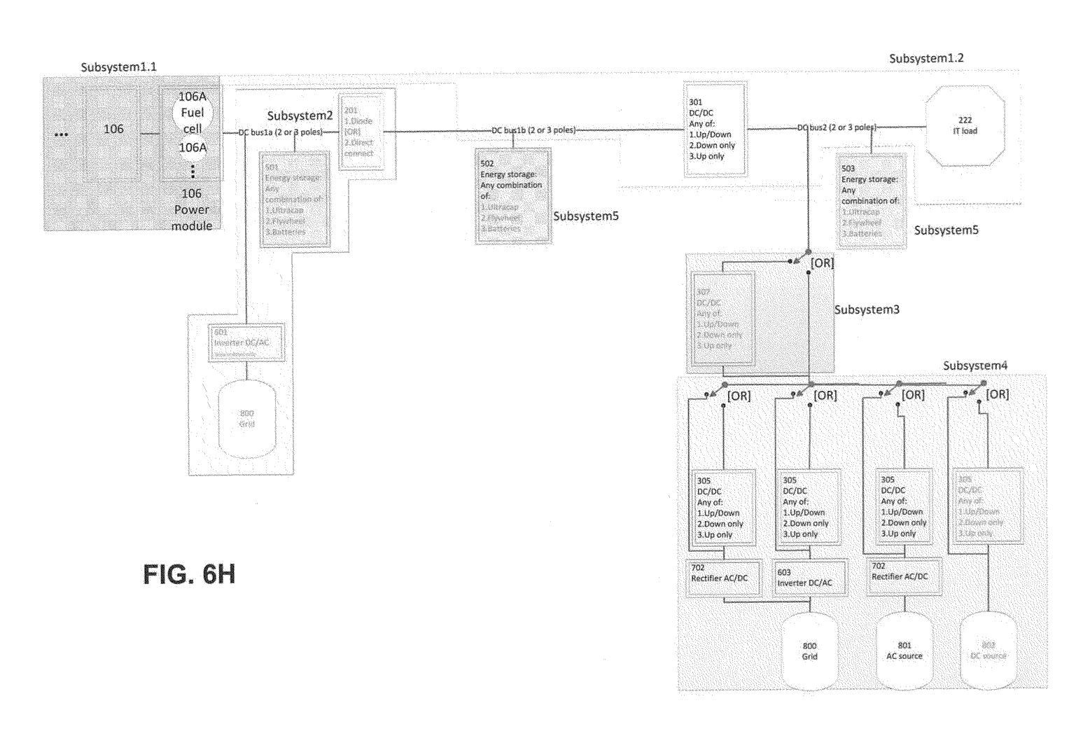

FIGS. 6A-6H are block diagrams illustrating a configurable fuel cell system according to embodiments. FIG. 6A illustrates a power modules 106 each having one or more fuel cells 106A. The power module is identified as subsystem 1.1.

The subsystem 1.1 may be connected to a subsystem 2 via a single or split bus. Subsystem 2 may be similar to the IOM 104 and the storage module 108 shown in FIG. 1A. Subsystem 2 includes a DC/AC inverter 601 (similar to the IOM inverter 104A in FIG. 1B) and an energy storage system 501 (similar to the storage module 108). The DC/AC inverter 601 supplies AC power to a grid 800 (e.g., similar to grid 114 in FIG. 1A). The DC/AC inverter 601 may be isolating or non-isolating. The energy storage system 501 may include one or more batteries, one or more ultracapacitors and one or more flywheel devices, among others.

Subsystem 2 provides power to single or split DC bus in subsystem 1.2 via connection 201. The connection 201 may made in various ways, including via a direct connection 201.2 as illustrated in FIG. 6B (for example, a conventional cable or busbar), via a diode connection 201.1 or via a low voltage forward drop device (for example, a silicon carbide diode).

Subsystem 1.2 includes a DC/DC converter 301. The DC/DC converter 301 may be similar to converter 106B shown in FIGS. 1A and 2-5) and may be a down-only converter, an up-only converter and a configurable converter that may be operated as either an up converter or a down converter (e.g., as a buck, boost or buck-boost converter). An output of DC/DC converter 301 supplies power to a DC load 222, such as an IT load.

Subsystem 1.2 may also supply power to or receive power from one or more DC/DC converters 302, 307 (subsystems 3) via a switching system, for example an or-gating device. The DC/DC converter 302, 307 may be down-only converters, up-only converters or configurable converters that may be operated as either an up converter or a down converter. In an embodiment, subsystem 3 comprises a switchable bidirectional DC bus that is connected to one or more subsystems 4.

Subsystem 4 may include either a bidirectional DC/DC converter 302 with one connection to the input bus and one connection to the output bus or it may include a direct connection bypassing the DC/DC converter 302 (in which case the converter 302 may be omitted).

The combination of subsystems 3 and 4 may be configured to provide at least one of the following:

1. A 800 grid connection attached either to an input of an AC/DC rectifier 701 (importing power from the grid) or to the output of a DC/AC inverter 602 (exporting power to the grid), or to both simultaneously (either to import or export power to/from the grid). The output of the 701 rectifier may be connected to either the input of a DC/DC converter 304 or to an input of a DC/DC converter 304 and the input of an inverter 602, or to the bidirectional DC bus only. The input of the inverter 602 may be connected to either the DC/DC bidirectional bus or a second output of DC/DC converter 304, or to the output of the rectifier 701 and the bidirectional DC bus. In an embodiment, the rectifier 701 is only used when the diode 201.1 of subsystem 2 is used.

2. An AC 801 source (for example, a grid or a diesel generator) connected to the input of an AC/DC rectifier 701. The output of the rectifier 701 is electrically connected to either the DC bidirectional bus or to a DC/DC converter 304.

3. Any suitable regulated or unregulated DC source 802 (for example, a wind farm, a solar array or another alternative power source) connected to either the input of a DC/DC converter 304 or the DC bidirectional bus.

In an embodiment, a first subsystem 3 is electrically connected to the DC bus ahead (i.e., on the input side) of the DC/DC converter 301 (see FIG. 6E) with respect to subsystem 1.1. In another embodiment, a second subsystem 3 is electrically connected to the DC bus after (i.e., on the output side of) the DC/DC converter 301 (see FIG. 6F) with respect to subsystem 1.1.

Subsystem 1.2 may also provide power to one or more subsystems 5 as shown in FIG. 6A. In an embodiment, a first subsystem 5 includes an energy storage system 502 and a bidirectional bus and a second subsystem 5 includes an energy storage system 503 and a bidirectional bus. The energy storage systems 502 and 503 may include one or more batteries, one or more ultracapacitors and one or more flywheel devices, among others.

In an embodiment, a single subsystem 5 may be electrically connected to the DC bus ahead or behind the DC/DC converter 301 with respect to subsystem 1.1.

FIGS. 6B-6H illustrate different configurations of the fuel cell system illustrated in FIG. 6A.

FIG. 6B illustrates a configuration that utilizes subsystems 1.1 and 1.2 and two subsystems 5, one connected on the input side of DC/DC converter 301 and one connected on the output side of DC/DC converter 301.

FIG. 6C illustrates a configuration that utilizes subsystems 1.1 and 1.2, subsystem 2 and two subsystems 5, one connected on the input side of DC/DC converter 301 and one connected on the output side of DC/DC converter 301.

FIG. 6D illustrates a configuration that utilizes subsystems 1.1 and 1.2, a subsystem 3 connected on the input side of DC/DC converter 301 and two subsystems 5, one connected on the input side of DC/DC converter 301 and one connected on the output side of DC/DC converter 301. The subsystem 3 provides power to a single subsystem 4.

FIG. 6E illustrates a configuration that utilizes subsystems 1.1 and 1.2, a subsystem 3 connected on the output side of DC/DC converter 301 and two subsystems 5, one connected on the input side of DC/DC converter 301 and one connected on the output side of DC/DC converter 301. The subsystem 3 provides power to a single subsystem 4.

FIG. 6F illustrates a configuration like the configuration in FIG. 6A with the exception that a subsystem 2 is not utilized.

FIG. 6G illustrates a configuration that utilizes subsystems 1.1 and 1.2, a subsystem 2, a subsystem 3 connected on the input side of DC/DC converter 301 and two subsystems 5, one connected on the input side of DC/DC converter 301 and one connected on the output side of DC/DC converter 301. The subsystem 3 provides power to a single subsystem 4.

FIG. 6H illustrates a configuration that utilizes subsystems 1.1 and 1.2, a subsystem 2, a subsystem 3 connected on the output side of DC/DC converter 301 and two subsystems 5, one connected on the input side of DC/DC converter 301 and one connected on the output side of DC/DC converter 301. The subsystem 3 provides power to a single subsystem 4.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

One or more block/flow diagrams have been used to describe exemplary embodiments. The use of block/flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

Control elements may be implemented using computing devices (such as computer) comprising processors, memory and other components that have been programmed with instructions to perform specific functions or may be implemented in processors designed to perform the specified functions. A processor may be any programmable microprocessor, microcomputer or multiple processor chip or chips that can be configured by software instructions (applications) to perform a variety of functions, including the functions of the various embodiments described herein. In some computing devices, multiple processors may be provided. Typically, software applications may be stored in the internal memory before they are accessed and loaded into the processor. In some computing devices, the processor may include internal memory sufficient to store the application software instructions.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

What is claimed is:

1. A fuel cell system, comprising:
at least one power module comprising at least one fuel cell segment configured to supply power to a DC IT load;
a first inverter configured to supply an alternating current (AC) to or from an AC grid;
a first DC bus electrically connected to an output of the at least one fuel cell segment and to an input for the first inverter, and configured to supply power to an input of the DC IT load; and
a first isolating DC/DC converter positioned to isolate the DC IT load from at least one of the first inverter or the AC grid.

2. The fuel cell system of claim 1, wherein an output of the first inverter is connected to the AC grid.

3. The fuel cell system of claim 1, wherein an input of the first inverter is connected to the AC grid.

4. The fuel cell system of claim 1, wherein the first DC bus supplies power to an input of the DC IT load.

5. The system of claim 1, wherein the first DC bus is selected from the group consisting of a unipolar DC bus and a bipolar DC bus.

6. The fuel cell system of claim 1, further comprising a storage device configured to supply power to or receive power from the first DC bus.

7. The fuel cell system of claim 4, further comprising a second DC bus, wherein the second DC bus is electrically connected to an output of the first isolating DC/DC converter and wherein the second DC bus is electrically connected to the input of the DC IT load.

8. The fuel cell system of claim 7, wherein:
the first isolating DC/DC converter is a down converter; and
an input of the first isolating DC/DC converter is electrically connected to the first DC bus such that a voltage provided on the second DC bus is less than a voltage on the first DC bus.

9. The fuel cell system of claim 7, further comprising:
a second inverter configured to receive power from an AC source; and
a second isolating DC/DC converter electrically connected to an output of the second inverter and the second DC bus, wherein the second isolating DC/DC converter isolates the DC IT load from at least one of the second inverter or the AC source.

10. The fuel cell system of claim 9, wherein the AC source is selected from the group consisting of the grid and an AC generator.

11. The fuel cell system of claim 7, further comprising a storage device configured to supply power to or receive power from the second DC bus.

12. The fuel cell system of claim 1, wherein:
the first inverter is configured to supply the AC to the AC grid;
an input of the first inverter electrically connected to an output of the first isolating DC/DC converter; and
an input of the first isolating DC/DC converter is electrically connected to the first DC bus.

13. The fuel cell system of claim 12, wherein:
the first isolating DC/DC converter is an up converter, such that a voltage on the first bus is less than a voltage on an output of the first isolating DC/DC converter; and
an output of the first inverter is electrically connected to the AC grid.

14. The fuel cell system of claim 13, further comprising:
a second inverter configured to receive power from an AC source; and
a second isolating DC/DC converter electrically connected to an output of the second inverter and the first DC bus, wherein the second isolating DC/DC converter isolates the DC IT load from at least one of the second inverter or the AC source.

15. The fuel cell system of claim 14, wherein the AC source is selected from the group consisting of the grid and an AC generator.

16. The fuel cell system of claim 12, further comprising a second isolating DC/DC converter, wherein an input of the second isolating DC/DC converter is electrically connected to the first bus and an output of the second isolating DC/DC converter is electrically connected to a second DC bus, and wherein the second DC bus is electrically connected the DC IT load.

17. The fuel cell system of claim 16, further comprising:
a second inverter configured to receive power from an AC source; and
a second isolating DC/DC converter electrically connected to an output of the second inverter and to the second DC bus, wherein the second isolating DC/DC converter isolates the DC IT load from at least one of the second inverter or the AC source.

18. The fuel cell system of claim 16, further comprising a third inverter configured to receive power from the AC grid, wherein an output of the third inverter is connected first DC bus.

19. The fuel cell system of claim 1, wherein the first inverter is configured to supply AC from the AC grid.

20. The fuel cell system of claim 19, further comprising:
a second DC bus electrically connected to the output of the at least one fuel cell segment and to an input of a second inverter, wherein the second inverter is configured to supply the AC to the AC grid.

21. A method of operating a fuel cell system, comprising:
supplying a direct current from at least one fuel cell segment to a DC IT load at least in part via a first DC bus; and
supplying an alternating current (AC) from an AC grid to a first inverter or receiving the AC from the AC grid at the first inverter,
wherein:
the first inverter is connected to the first DC bus; and
the DC IT load is isolated from at least one of the first inverter or the AC grid by an isolating DC/DC converter during the step of supplying the direct current.

22. The method of claim 21, further comprising:
supplying power from the first DC bus to an input of the first isolating DC/DC converter;
supplying power from an output of the first isolating DC/DC converter to a second DC bus; and
supplying power from the second DC bus to an input of the DC IT load.

23. The method of claim 22, wherein the first isolating DC/DC converter is a down converter and wherein a voltage on the second DC bus is less than a voltage on the first DC bus.

24. The method of claim 22, further comprising:
providing power to an input of a second inverter from an AC source;
providing power from of an output of the second inverter to an input of a second isolating DC/DC converter; and
providing power from an output of the second DC/DC converter to the second DC bus, wherein the second isolating DC/DC converter isolates the DC IT load from at least one of the second inverter or the AC source.

25. The method of claim 24, wherein the AC source is selected from the group consisting of the grid and an AC generator.

26. The method of claim 21, further comprising:
supplying power to an input of the first isolating DC/DC converter from the first DC bus;
supplying power to an input of the first inverter power from the output of the first isolating DC/DC converter; and
supplying power from an output of the first inverter AC to the AC grid.

27. The method of claim 26, wherein the first isolating DC/DC converter is an up converter and wherein a voltage on the first bus is less than a voltage on an output of the first isolating DC/DC converter.

28. The method of claim 26, further comprising:
supplying power to an input of a second inverter from an AC source;
supplying power from an output of the second inverter to an input of a second isolating DC/DC converter; and
supplying power from an output of the second inverter to the first DC bus, wherein the second isolating DC/DC converter isolates the DC IT load from at least one of the second inverter or the AC source.

29. The method of claim 28, wherein the AC source is selected from the group consisting of the grid and an AC generator.

30. The method of claim 21, further comprising;
providing power from the first bus to a second isolating DC/DC converter;
providing power from an output of the second isolating DC/DC converter to a second DC bus; and
providing power from the second DC bus to the DC IT load.

31. The method of claim 30, further comprising:
providing power to an input of a second inverter from an AC source;
providing power from an output of the second inverter to an input of a second isolating DC/DC converter; and
providing power from an output of the second isolating DC/DC converter to the second DC bus, wherein the second isolating DC/DC converter isolates the DC IT load from at least one of the second inverter or the AC source.

32. The method of claim 21, further comprising:
supplying power to an input of the first inverter from the AC grid;
supplying power from an output of the first inverter to an input of the first isolating DC/DC converter; and
supplying power from an output of the first isolating DC/DC converter to the first DC bus.

33. The method of claim 32, further comprising:
supplying a direct current from at least one fuel cell segment to a second DC bus;
supplying power from the second DC bus to an input of a second inverter; and
supplying power from an output of the second inverter to the AC grid.

34. The method of claim 33, wherein:
supplying the direct current from the at least one fuel cell segment to a DC IT load at least in part via the first DC bus comprises supplying the direct current from the at least one fuel cell segment to the isolating DC/DC converter and from the isolating DC/DC converter to the DC IT load via the first DC bus; and
supplying the direct current from the at least one fuel cell segment to the second DC bus comprises supplying the direct current from the at least one fuel cell segment to a non-isolating DC/DC converter located electrically in parallel with the isolating DC/DC converter, and from the non-isolating DC/DC converter to the second DC bus.

35. The method of claim 21, wherein the isolating DC/DC converter shares the IT load unequally with at least one second DC/DC converter.

36. The method claim 21, wherein the first DC bus receives power from or sends power to a switchable bidirectional bus.
